(19) United States
(12) Patent Application Publication
(10) Pub. No.: US 2007/0106043 A1
(43) Pub. Date: May 10, 2007

(54) Method of producing acrylic copolymer

(76) Inventors: Masayoshi Horiuchi, Ibaraki (JP); Toshimasa Sagawa, Ibaraki (JP); Hanuyoshi Tatsu, Ibaraki (JP)

Correspondence Address: BUTZEL LONG, 350 SOUTH MAIN STREET, SUITE 300, ANN ARBOR, MI, 48104, US

(21) Appl. No.: 10/587,640

(22) PCT Filed: Mar. 22, 2005
(86) PCT No.: PCT/JP05/05114

§ 371 Date: Jul. 28, 2006

(30) Foreign Application Priority Data
Mar. 24, 2004 (JP) 2004-086082

(51) Int. Cl. C08F 220/22

(52) U.S. Cl. 526/245; 526/303.1; 526/319

(57) ABSTRACT

In the production of an acrylic copolymer by emulsion polymerization of a monomer mixture comprising (a) 30-70% by weight of perfluoroalkylalkyl (meth)acrylate, represented by the following general formula: CH₂═CRCOOR′ Rf (where R is a hydrogen atom or a methyl group, R′ is a linear or branched alkylene group having 1-8 carbon atoms, and Rf is a perfluoroalkyl group having 4-16 carbon atoms), (b) 25-60% by weight of stearyl (meth)acrylate, (c) 0.1-5% by weight of (meth)acrylamide, and (d) 0.1-5% by weight of N-methylol (meth)acrylamide, in the presence of a non-ionic and/or cationic surfactant, a polypropylene glycol-based compound having a molecular weight of 250-5,000 is used as an emulsification aid at the same time. The resulting aqueous dispersion of acrylic copolymer has distinguished preservation stability, and water and oil repellency.

### TECHNICAL FIELD

The present invention relates to a method for producing an acrylic copolymer, and more particularly to a method for producing an acrylic copolymer by emulsion polymerization, which can be used as an effective component of a water and oil repellent, etc.

### BACKGROUND ART

The present applicant has so far proposed a water and oil repellent comprising an acrylic copolymer as an effective component, prepared by copolymerization of (a) perfluoroalkylethyl (meth)acrylate, (b) stearyl (meth)acrylate, (c) 2-chloroethyl vinyl ether, (d) N-methylol (meth)acrylamide, and if necessary (e) hydroxyalkyl (meth)acrylate. In the production of the acrylic copolymer by emulsion polymerization, a monomer mixture for use in the polymerization reaction has problems of mechanical emulsificability and polymerization stability, and the resulting emulsion fails to fully satisfy the emulsion stability, preservation stability and further the washing stability when used as a water and oil repellent.
Patent Literature 1: JP-A-10-237133

A method for producing a fluoropolymer by emulsifying a monomer mixture comprising fluorinated (meth)acrylic monomer and acrylamide as essential components by a powerful emulsification means and by miniemulsion polymerization, stabilized with a non-ionic, anionic or cationic surfactant, for example, sulfosuccinic acid such as sodium bis(tridecyl) sulfosuccinate or quaternary ammonium salt, substantially in the absence of a solvent, has been also proposed. However, the resulting fluoropolymer emulsion shows no water repellency at all to fibers.
Patent Literature 2: JP-A-2002-530443

When N-methylol acrylamide is used as an acrylamide, however, the resulting fluoropolymer emulsion shows a good water and oil repellency to polyamide fibers, but the resulting emulsion has larger particle sizes and poor preservation stability. Actually, it is a polymerization reaction product ready to form scum or precipitates.

### DISCLOSURE OF THE INVENTION

### PROBLEM TO BE SOLVED BY THE INVENTION

An object of the present invention is to provide a method for producing an acrylic polymer with a distinguished mechanical emulsificability of monomer mixture, a distinguished emulsion stability at the time of polymerization and formation, and a good water and oil repellency.

### MEANS FOR SOLVING THE PROLLEM

The object of the present invention can be attained by producing an acrylic copolymer, using a polypropylene glycol-based compound having a molecular weight of 250-5,000 as an emulsification aid simultaneously in emulsion polymerization of monomer mixture comprising (a) 30-70% by weight of perfluoroalkylalkyl (meth)acrylate, represented by the following general formula:
CH₂═CRCOOR′ Rf
(where R is a hydrogen atom, or a methyl group, R′ is a linear or branched alkylene group having 1-8 carbon atoms, and Rf is a perfluoroalkyl group m having 4-16 carbon atoms), (b) 25-60% by weight of stearyl (meth)acrylate, (c) 0.1-5% by weight of (meth)acrylamide, and (d) 0.1-5% by weight of N-methylol (meth)acrylamide, in the presence of a non-ionic and/or cationic surfactant, where the term “(meth)acrylate” means acrylate or metha-crylate, and “(meth)acrylamide” means acrylamide or methacrylamide, respectively.

### EFFECT OF THE INVENTION

According to the present method for producing an acrylic copolymer, such effects can be obtained that the acrylic copolymer obtained as an aqueous dispersion has a distinguished water and oil repellency, and the aqueous dispersion has small values each of percent weight ratio of precipitates, and 10%, 50% and 90% particle sizes, and also has a distinguished preservation stability.

### BEST MODES FOR CARRYING OUT THE INVENTION

Perfluoroalkylalkyl (meth)acrylate such as
CH₂═CHCOOCH₂Rf,
CH₂═C(CH₃)COOCH₂Rf,
CH₂═CHCOO(CH₂)₂Rf,
CH₂═C(CH3)COO(CH)₂Rf,
CH₂═CHCOO(CH₂₎_{3Rf,}
CH₂═C(CH₃)COO(CH₂)₃Rf,
CH₂═CHCOO(CH₂)₄Rf,
CH₂═C(CH₃)COO(CH₂)₄Rf,
CH₂═CHCOO(CH₂)₂(CF₂)nCF(CF₃)₂,
CH₂═C(CH₃)COO(CH₂)₂(CF₂)nCF(CF₃)₂, etc.
   can be copolymerized in a proportion of about 30 to about 70% by weight, preferably about 35 to about 65% by weight in the copolymer as Component (a). When the copolymerization proportion is less than about 30% by weight, the water and oil repellency cannot be fully exhibited. As a perfluoroalkyl group Rf, mixed groups having 4-16 carbon atoms may be used.

Stearyl (meth)acrylate group as Component (b) can be copolymerized in a proportion of about 25 to about 60% by weight, preferably about 30 to about 60% by weight in the copolymer. When the copolymerization proportion is less than about 25% by weight, any good water repellency cannot be obtained any more.

(Meth)acrylamide as Component (c) can be copolymerized in a proportion of about 0.1 to about 5% by weight, preferably about 1 to about 4% by weight, in the copolymer. When the copolymerization proportion is less than about 0.1% by weight, the monomer emulsificability will become poor, resulting in a decrease in the water and oil repellency and the emulsion preservation stability.

N-methylol (meth)acrylamide as Component (d) can be copolymerized in a proportion of about 0.1 to about 5% by weight, preferably about 0.5 to about 3% by weight, in the copolymer. When the copolymerization proportion is less than about 0.1% by weight, no improvement of the water and oil repellency and the durability will be attained.

In the case of copolymerizing these Components (c) and (d), simultaneous use of a cross-linking agent such as methyloled melamine, blocked isocyanate, etc. can further improve the durability.

Other copolymerizable monomers can be copolymerized into the copolymer in such a range as not to deteriorate the characteristics, for example, in a proportion of not more than 30% by weight in the copolymer. Such copolymerizable monomers include, for example, vinyl compounds m such as styrene, vinyltoluene, α-methylstyrene, vinylnaphthalene, acrylonitrile, methacrylonitrile, acetone acrylamide, 2-hydroxyethyl acrylate, 4-hydroxybutyl acrylate, 2-hydroxy-3-chloropropyl (meth)acrylate, vinyl chloride, vinylidene chloride, vinyl fluoride, vinylidene fluoride, chloroethyl vinyl ether, hydroxyethyl vinyl ether, hydroxybutyl vinyl ether, pentafluoropropyl (meth)acrylate, trifluoroethyl (meth)acrylate, etc., and diene compounds such as isoprene, pentadiene, butadiene, etc.

If necessary, a polyfunctional monomer or an oligomer can be also copolymerized in a proportion of not more than 30% by weight in the copolymer. Such a polyfunctional monomer or oligomer includes, for example, ethylene glycol di(meth)acrylate, propylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, tetraethylene glycol di(meth)acrylate, tripropylene glycol di(meth)acrylate, polypropylene glycol di(meth)acrylate, bisphenol A. ethylene oxide adduct diacrylate, dimethylol tricyclodecane diacrylate, glycerine methacrylate acrylate, 3-acryloyloxyglycerine monomethacrylate, etc.

To facilitate the emulsion dispersibility of copolymer, a hydrophilic monomer such as a quaternary salt of N,N-dimethylaminoethyl (meth)acrylate, polyethylene glycol mono(meth)acrylate, polypropylene glycol mono(meth)acrylate, polyethylene glycol polypropylene glycol mono(meth)acrylate, etc. can be further copolymerized in a proportion of not more than 1% by weight in the copolymer comprising these individual monomer components.

Copolymer can be produced by an emulsion polymerization process. In the emulsion polymerization process, the individual monomers are emulsion dispersed into an aqueous medium by various surfactants, preferably a non-ionic surfactant, a cationic surfactant, or a mixture thereof, and polymerization reaction is carried out at about 65° to about 75° C. in the presence of a radical initiator such as 2,2′-azobis(2-aminopropane).dihydrochloride, azobisisobutylamidine .hydrochloride, etc. Before the emulsion polymerization reaction, the monomer mixture can be emulsion dispersed into the aqueous medium by a powerful emulsification means such as a high pressure homogenizer, a colloid mill, an ultrasonic wave dispersing apparatus, etc.

That is, these individual monomers can be copolymerized in the presence of a surface-active emulsifying agent, preferably a polyethylene oxide-based non-ionic surfactant or a cationic surfactant, and a polypropylene glycol-based compound having a molecular weight of 250-5,000, preferably 300-3,000, as an emulsification aid. The present applicant has already proposed polymerization reaction in polypropylene glycol having an average molecular weight of not more than about 1,000 in the production of an anti-fouling processing agent by copolymerization of a fluoroalkyl group-containing monomer with a hydrophilic group-containing monomer, where the low molecular weight polypropylene glycol is used as a solvent for the solution polymerization reaction, but not as an emulsification aid for the emulsion polymerization process.
Patent Literature 3: JP-A-2001-106711

As a surfactant acting as an emulsifying agent, preferably at least one of polyethylene oxide-based non-ionic surfactants and cationic surfactants can be used in a proportion of 1-20% by weight, preferably 5-15% by weight, on the basis of the amount of total monomers. The polyethylene oxide-based non-ionic surfactant for use herein includes, for example, condensation products of polyethylene oxide with hexylphenol, octylphenol, nonylphenol, polycyclic phenyl ether, hexadecanol, oleic acid, C_{12-C}₁₈ alkylamines, sorbitan monofatty acid, etc., and preferably a condensation product of polyethylene oxide with octylphenol or nonylphenol. The cationic surfactant for use herein includes, for example, quaternary ammonium salts such as stearyltrimethyl ammonium chloride, distearyldimethyl ammonium chloride, dodecyltrimethyl ammonium acetate, dodecyltrimethyl ammonium chloride, tetradecyltrimethyl ammonium chloride, hexadecyltrimethyl ammonium chloride, octadecyltrimethyl ammonium chloride, dodecylbenzyltrimethyl ammonium chloride, dodecylmethyldi(polyoxyethylene) ammonium chloride, dioctadecyldimethyl ammonium chloride, etc., and alkylpyridinium salts.

As a polypropylene glycol-based compound for use as an emulsification aid in combination with these emulsifying agents, polypropylene glycol, polypropylene glycol-terminated monomethyl ether, propylene glycol adducts of glycerine, etc. can be used in a proportion of 10-100% by weight, preferably 15-70% by weight, on the basis of the amount of total monomers. In the case of using no such polypropylene glycol-based compounds or using dipropylene glycol (molecular weight: 134) or 1,6-hexanediol in place thereof, the emulsion stability of the aqueous dispersion, given by percent weight ratio of precipitates, and 10%, 50%, and 90% particle sizes, will be lowered. Also, in the case of using polypropylene glycol-based compounds having a molecular weight of more than 5,000, the emulsion stability will be likewise lowered.

Emulsion polymerization product can be used as a water and oil repellent upon further dilution of an aqueous dispersion having a concentration of solid matters of about 10 to about 40 wt. %, to about 0.05 to about 5 wt. % with water.

Copolymer solution or aqueous dispersion diluted to such a concentration can be applied to materials to be treated by such a means as spraying, dipping, foam coating, etc. The materials to be treated include, for example, fiber products, leather, glass, ceramics, metals, plastics, etc., and the present water and oil repellent can be particularly effectively applied to products of natural fibers of cotton, hemp, silk, etc., synthetic fibers of polyamide, polyester, etc., semi-synthetic fibers of rayon, acetate, etc., or their mixed fibers.

### EXAMPLES

The present invention will be described in detail below, referring to Examples.

### Example 1

| | Parts by weight |
|---|---|
| Perfluoroalkylethyle acrylate | 133.5 |
| (a mixture of total 91% Rf groups: 6% C₆, 52% C₈, | |
| 24% C₁₀, 7% C₁₂, and 2% C₁₄; average number of | |
| carbon atoms: 8.8) | |
| Stearyl acrylate | 82.4 |
| Stearyl methacrylate | 66.1 |
| Lauryl mercaptan | 0.9 |
| Polypropylene glycol | 57.0 |
| (Uniol D-400, a NOF Corp. product; mol. wt.: 400) | |
| Polyoxyethylene (n: 20) mono(octylphenyl) ether | 9.0 |
| Stearyltrimethyl ammonium chloride | 7.3 |
| Distearyldimethyl ammonium chloride | 17.4 |
| Deionized water | 400.1 |

The foregoing components were charged into a reactor and subjected to emulsification treatment for 5 times at 60 MPa, using a high pressure homogenizer. The resulting emulsion was flushed with a nitrogen gas for 30 minutes, and then the inside temperature of the reactor was slowly elevated to 40° C., followed by successive addition of
7.8 parts by weight of acrylamide and 4.0 parts by weight of N-methylol acrylamide dissolved in 100 parts by weight of deionized water
5.9 parts by weight of 2,2′-azobis(2-amidinopropane).dihydro-chloride dissolved in 100 parts by weight of deionized water thereto, and by further slow elevation of the inside temperature to 70° C. to conduct the reaction for 4 hours. After the reaction, 978 parts by weight of an aqueous dispersion having a concentration of solid matters of 32 wt. % was obtained upon cooling.

### Example 2

In Example 1, the same amount of a mixture of perfluoroalkylethyl acrylates having total 91% Rf groups: 2% C₆, 39% C₈, 37% C₁₀, 10% C₁₂, 2% C₁₄, 0.6% C₁₆, and 0.1% C₁₈ and an average number of carbon atoms: 9.4 was used.

### Comparative Example 1

| | Parts by weight |
|---|---|
| Perfluoroalkylethyl acrylate | 150.0 |
| (a mixture of total 91% Rf groups: 6% C₆, 52% C₈, | |
| 24% C₁₀, 7% C₁₂, and 2% C₁₄; average number of | |
| carbon atoms: 8.8) | |
| Stearyl acrylate | 75.0 |
| 2-chloroethyl vinyl ether | 15.0 |
| 2-hydroxyethyl methacrylate | 3.0 |
| Lauryl mercaptan | 0.9 |
| Acetone | 30.0 |
| Polyoxyethylene (n: 20) mono(octylphenyl) ether | 1.0 |
| Stearyltrimethyl ammonium chloride | 1.0 |
| Deionized water | 510.0 |

The foregoing components were charged into a reactor, and subjected to emulsification treatment for 5 times at 60 MPa, using high pressure homogenizer, and the resulting emulsion was flushed with a nitrogen gas for 30 minutes. Then, the inside temperature of the reactor was slowly elevated to 40° C., followed by successive addition of
3.0 parts by weight of acrylamide dissolved in 100 parts by weight of deionized water
5.9 parts by weight of 2,2′-azobis(2-amidinopropane).dihydro-chloride dissolved in 100 parts by weight of deionized water thereto, and further by slow elevation of the inside temperature to 70° C. to conduct the reaction for 4 hours. After the reaction, 968 parts by weight of an aqueous dispersion having a concentration of solid matters of 25 wt. % was obtained upon cooling.

### Comparative Example 2

| | Parts by weight |
|---|---|
| Perfluoroalkylethyl acrylate | 8.3 |
| (a mixture of total 91% Rf groups: 6% C₆, 52% C₈, | |
| 24% C₁₀, 7% C₁₂, and 2% C₁₄; average number of | |
| carbon atoms: 8.8) | |
| Sodium bis(tridecyl)sulfosuccinate | 4.0 |
| Borax | 0.1 |
| Deionized water | 480.0 |

The foregoing components were charged into a reactor and stirred at 65° C. for 30 minutes. Then, the following components were added thereto, while continuing the stirring:

| | Parts by weight |
|---|---|
| Said perfluoroalkylethyl acrylate | 59.8 |
| 2-ethylhexyl methacrylate | 58.6 |
| N-methylol acrylamide | 1.3 |
| Methacrylic acid | 0.4 |

After the addition, the mixture was subjected to emulsification treatment for 6 times at 60 MPa, using a high pressure homogenizer, and the resulting emulsion was flushed with a nitrogen gas for 30 minutes. Then, the inside temperature of the reactor was slowly elevated to 88° C., while flushing a nitrogen gas thereto, followed by addition of
0.8 parts by weight of potassium persulfate dissolved in 7.0 parts by weight of deionized water
   and inside temperature was slowly elevated to 70° C., and then the same amount of the initiator solution was continuously added thereto for one hour to conduct the reaction for further one hour. After the reaction, 610 parts by weight of an aqueous dispersion having a concentration of solid matter of 20 wt. % was obtained upon cooling.

### Comparative Example 3

| | Parts by weight |
|---|---|
| Perfluoroalkylethyle acrylate | 200.0 |
| (a mixture of total 91% Rf groups: 6% C₆, 52% C₈, | |
| 24% C₁₀, 7% C₁₂, and 2% C₁₄; average number of | |
| carbon atoms: 8.8) | |
| Stearyl acrylate | 65.0 |
| N-methylol acrylamide | 4.1 |
| N-methylol methacrylamide | 5.5 |
| Lauryl mercaptan | 0.3 |
| Polyoxyethylene (n: 20) mono(octylphenyl) ether | 12.0 |
| Distearyldimethyl ammonium chloride | 13.0 |
| Deionized water | 670.0 |

The foregoing components were charged into a reactor and subjected to emulsification treatment for 5 times at 60 MPa, using a high pressure homoginizer, and the resulting emulsion was flushed with a nitrogen gas for 30 minutes. Then, the inside temperature of the reactor was slowly elevated to 40° C. Then,
2.0 parts by weight of 2,2′-azobis(2-amidinopropane).dihydro-chloride dissolved in 20 parts by weight of deionized water was added thereto, and the inside temperature of the reactor was slowly elevated to 70° C. to conduct the reaction for 4 hours. After the reaction, 970 parts by weight of an aqueous dispersion having a concentration of solid matters of 33 wt. % was obtained upon cooling.

Concentrations of solid matters of the aqueous dispersions obtained in the foregoing Examples and Comparative Examples were diluted to a concentration of 0.5 wt. % with deionized water, and cotton cloth, mixed spun cloth of cotton/polyester, and polyester cloth were dipped thereto to determine water repellency and oil repellency. After the squeezing, wet pick up was found to be 90% for the cotton cloth, 65% for the mixed spun cloth of cotton/polyester, and 60% for the polyester cloth, and the drying-curing conditions were 180° C. for 3 minutes.

Water repellency: by spray procedure according to JIS L-1092 (the higher the degree of water repellence, the better the water repellency)

| Degree of water repellence | Wet state |
|---|---|
| 0 | Wetting throughout the surface side and |
| | backside |
| 50 | Wetting throughout the surface side |
| 70 | Wetting on a half of the surface side with |
| | small individual spots of wetting |
| | permeated through the cloth |
| 80 | Small individual water droplet-like spots |
| | of wetting on the surface side |
| 90 | No wetting on the surface side, but small |
| | spots of water droplets thereon |
| 100 | Neither wetting nor water droplet spots |
| | on the surface side |

Oil repellency: Oil repelling grades according to AATCC TM-118 (grades of test liquids when droplets of a test liquid can be retained for at least 30 seconds) (the higher the oil repelling grade, the better the oil repellency)

| Oil repelling grade | Test liquid |
|---|---|
| 0 | Permeation of Kaydol (liquid paraffin, a Witco |
| | product) |
| 1 | Kaydol |
| 2 | Kaydol/n-hexadecane liquid mixture (Volume |
| | ratio: 65:35) |
| 3 | n-hexadecane |
| 4 | n-tetradecane |
| 5 | n-dodecane |
| 6 | n-decane |
| 7 | n-octane |
| 8 | n-heptane |

80 g of the aqueous dispersions prior to the dilution with deionized water were taken into centrifuge tubes and then subjected to centrifugal separation at 3,000 rpm for 30 minutes. Percent weight ratios of precipitates were calculated from the weights of precipitates dried at 120° C. for 3 hours. Particle sizes for cumulative frequencies 10%, 50%, and 90% in the order of smaller to larger particle sizes were determined as 10% particle size, 50% particle size (average particle size), 90% particle size, correspondingly, using a particle size distribution meter, MICROTRAC UPA150.

70 g of aqueous dispersions prior to the dilution with deionized water were taken into screw tubes and placed in a thermostat at 55° C. to stand for one week, and preservation stability was evaluated from the precipitation state at the bottoms of the screw tubes and the upper liquid state. Evaluation was made in 6 grades as given below, where the smaller figures, the better the grade.

| Grade | State |
|---|---|
| 1 | No precipitates on the bottom without any change in the |
| | upper liquid state. |
| 2 | Precipitates existing partly on the bottom without any |
| | change in the upper liquid state. |
| 3 | Precipitates existing thinly on the bottom without any |
| | change in the upper liquid state. |
| 4 | Precipitates existing on the entire bottom, while the liquid is |
| | observable from the bottom side. No change in the upper |
| | liquid state. |
| 5 | Precipitates existing on the entire bottom, while the liquid is |
| | not observable from the bottom side. No change in the |
| | upper liquid state. |
| 6 | The upper liquid becomes gelled or is separated into layers, |
| | and the upper liquid state is changed. |

Results of determination is Examples 1 and 2 and Comparative Examples 1 to 3 are shown in the following Table.

TABLE

| | | | | | |
|---|---|---|---|---|---|
| Items of Determination | Ex. 1 | Ex. 2 | Comp. Ex. 1 | Comp. Ex. 2 | Comp. Ex. 3 |

[Water repellency]

| | | | | | |
|---|---|---|---|---|---|
| Cotton cloth | 90 | 90 | 80 | 0 | 70 |
| Mixed spun cloth of cotton/polyester | 100 | 100 | 100 | 50 | 90 |
| Polyester cloth | 100 | 100 | 100 | 50 | 90 |

[Oil repellency]

| | | | | | |
|---|---|---|---|---|---|
| Cotton cloth | 6 | 5 | 4 | 1 | 2 |
| Mixed spun cloth of cotton/polyester | 8 | 7 | 5 | 2 | 4 |
| Polyester cloth | 7 | 7 | 6 | 2 | 5 |

[Aqueous dispersion]

| | | | | | |
|---|---|---|---|---|---|
| Percent wt. ratio of precipitates (%) | 0.002 | 0.011 | 0.429 | 0.362 | 0.643 |
| 10% particle size (μm) | 0.0274 | 0.0291 | 0.0370 | 0.0611 | 0.0775 |
| 50% particle size (μm) | 0.0441 | 0.0456 | 0.0697 | 0.1322 | 0.1538 |
| 90% particle size (μm) | 0.0732 | 0.0827 | 0.1210 | 0.2163 | 0.2649 |
| Preservation stability | 2 | 3 | 5 | 5 | 5 |

### INDUSTRIAL UTILITY

A water and oil repellent based on the present copolymer can be effectively used in various fiber products including natural fibers without any deterioration of feeling or any yellowing, and low temperature curing or short time curing can be carried out.

1. A method for producing an acrylic copolymer, which comprises emulsion polymerizing a monomer mixture of (a) 30-70% by weight of perfluoroalkylalkyl (meth)acrylate, represented by the following general formula:
CH₂═CROOR′Rf
(where R is a hydrogen atom or a methyl group, R′ is a linear or branched alkylene group having 1-8 carbon atoms, and Rf is a perfluoroalkyl group having 4-16 carbon atoms), (b) 25-60% by weight of stearyl (meth)acrylate, (c) 0.1-5% by weight of (meth)acrylarnide, and (d) 0.1-5% by weight of N-methylol (meth)acrylamide in the presence of a non-ionic and/or cationic surfactant, wherein a polypropylene glycol-based compound is used as an emulsification aid.

2. A method of producing an acrylic copolymer according to claim 1, wherein alter the monomer mixture is emulsified and dispersed by an emulsification means using a high pressure homogenizer, a colloid mill or an ultrasonic dispersing apparatus, the emulsion polymerization is carried out by adding a polymerization initiator thereto.

3. An emulsion polymerized acrylic copolymer produced by a method according to claim 1.

4. A water and oil repellent, which comprises an emulsion polymerized acrylic copolymer according to claim 3.

5. An emulsion polymerized acrylic copolymer produced by a method according to claim 2.

6. A water and oil repellent, which comprises an emulsion polymerized acrylic copolymer according to claim 5.
